(19) United States
(12) Patent Application Publication
(10) Pub. No.: US 2006/0186058 A1
(43) Pub. Date: Aug. 24, 2006

(54) Ionized-water supplying apparatus using in-water plasma discharging

(76) Inventor: Anderson H. Kim, Thomas River, NJ (US)

Correspondence Address: John W. Renner;Renner, Otto, Boisselle & Sklar, LLP, Nineteenth Floor, 1621 Euclid Avenue, Cleveland, OH, 44115, US

(21) Appl. No.: 11/338,243

(22) Filed: Jan. 24, 2006

(30) Foreign Application Priority Data
Jul. 30, 2003 (KR) 20-2003-0024555
Jul. 19, 2004 (KR) 10-2004-0055829

(51) Int. Cl. C02F 1/32

(52) U.S. Cl. 210/748

(57) ABSTRACT

The present invention, equipped in a vessel such as cup, conducts in-water discharging that makes water plasma-ionized, whereby anions such as O₃⁻, OH⁻. HOCl, H₂O₂ being capable of sterilizing bacteria in water and water with no bacteria can be supplied. An ionized-water supplying apparatus according to the present invention is composed of a vessel to contain water, an in-water ionizing unit to make water in the vessel plasma-ionized, and a power supplying unit to supply electric power for the in-water ionizing unit.

### TECHNICAL FIELD

The present invention relates to an ionized-water supplying apparatus using in-water plasma discharging, and more particularly, to an ionized-water supplying apparatus using in-water plasma discharging wherein water is made into a plasma-ionized state through in-water discharging by means of a device for conducting in-water plasma discharging provided in a vessel such as a cup such that generated anions (O₃⁻, OH⁻, HOCl, H₂O₂) can sterilize bacteria in water to produce sterilized water with disinfecting action.

### BACKGROUND ART

To eliminate foul breath and prevent gingival disease, most people brush their teeth with toothbrush and toothpaste or gargle their throat with medicine such as mouthwash. Foul breath occurs due to an acquired systematic disease or from foul-smelling materials generated when protein, scraps of food and the like in saliva are digested into amino acids by means of microorganisms in the oral cavity and the amino acids are then are dissolved by means of decarboxyl or deaminase. Further, when people eat materials such as garlic or red pepper, foul breath occurs due to sulfide contained in the materials.

Such mouthwashes are in the form of tablets including cellulose, foaming agents, polishing agents, organic acids, preventive agents of dental caries, and the like, and also utilize the effect of effervescence. Since toothpaste utilizes peroxide as a formulation containing water such as gargling water, it is difficult for the toothpaste to be effective in the oral cavity.

Therefore, since oral cavity cleansing through tooth brushing or gargling temporarily eliminates foul breath, and neither remedy lasts for a long time nor fully removes the bacteria residing in the mouth, there is a problem in that the cause of gingival disease, oral caries and tooth discoloration still remains. Further, there is a disadvantage in that oral hygiene cannot be maintained in a clean state and that a feeling of freshness cannot last for a long time.

### SUMMARY OF INVENTION

Accordingly, the present invention is conceived the aforementioned problems in the prior art. An object of the present invention is to provide an ionized-water supplying apparatus using in-water plasma discharging wherein water is made into a plasma-ionized state through in-water discharging by means of a device for conducting the in-water plasma discharging provided in a vessel such as a cup such that generated anions (O₃⁻, OH⁻, HOCl, H₂O₂) can sterilize bacteria in water to produce sterilized water with disinfecting action.

According to a first embodiment of the present invention for achieving the object, there is provided an ionized-water supplying apparatus for producing disinfecting or sterilizing water using anions created by making water into an in-water plasma-ionized state through an in-water discharging operation, which comprises a vessel for containing water, an in-water plasma ionizing unit for making the water in the vessel into an in-water plasma-ionized state through the in-water discharging operation, and an electric power control unit for controlling supply of electric power needed to operate the in-water plasma ionizing unit.

According to a second embodiment of the present invention for achieving the object, there is provided ionized-water supplying apparatus for producing sterilized water with disinfecting action using anions (O⁻, O₃⁻, OH⁻, HOCl, H₂O₂) created through an in-water discharging operation, which comprises a vessel for containing water, an in-water plasma ionizing unit for making the water in the vessel into an in-water plasma-ionized state through the in-water discharging operation, a power switch for switching the supply of electric power, a power unit for converting the electric power from AC electric power into DC electric power and outputting the converted DC electric power, a switching unit for switching on or off the supply of electric power from the power unit to the connection unit, a control unit for causing an ON control signal to be applied to the switching unit and the DC power to be supplied from the power unit to the in-water plasma ionizing unit when the power switch is switched on, and causing an OFF control signal to be applied to the switching unit and the electric power to be cut off after a predetermined time has elapsed, a bell output unit for outputting bell sound or music under the control of the control unit, and a sensing unit for transmitting a sensed signal to the control unit when the sensor senses the presence of water.

According to a third embodiment of the present invention for achieving the object, there is provided an ionized-water supplying apparatus for producing sterilized water with disinfecting action using anions created by making water into an in-water plasma-ionized state through an in-water discharging operation, which comprises a water tank for containing water, an in-water discharging unit for making the water in the water tank into an in-water plasma ionized state through the in-water discharging operation, a coupling/supporting unit for coupling and supporting the water tank and the in-water discharging unit, and an electric power supply unit for supplying and controlling electric power needed for the in-water discharging operation of the in-water discharging unit.

### BRIEF DESCRIPTION OF THE DRAWINGS

FIG. 1 is a perspective view showing the external configuration of an ionized-water supplying apparatus 100 using plasma discharging according to a first embodiment of the present invention.

FIG. 2 is an exploded perspective view of an in-water plasma-ionizing unit 120.

FIG. 3 is a block diagram schematically illustrating the internal configuration of an electric power control unit 130.

FIGS. 4a and 4b show a state where the in-water plasma-ionizing unit 120 with a vessel 110 fastened thereto is seated on the electric power control unit 130.

FIG. 5 is a perspective view showing the external configuration of an ionized-water supplying apparatus 600 using the plasma discharging according to a second embodiment of the present invention.

FIG. 6 is a perspective view of an in-water discharging unit 620 mounted with a single set of in-water discharging plates.

FIG. 7 is an exploded perspective view of an in-water discharging unit mounted with the multiple sets of the in-water discharging plates.

FIG. 8 is an assembled perspective view of the in-water discharging unit mounted with the multiple sets of the in-water discharging plates.

FIG. 9 is a view illustrating the partial configuration of a power supply unit for supplying an ionized-water supplying apparatus 600 with electric power.

FIG. 10 is an exploded perspective view illustrating the operating principle of the in-water discharging unit 620.

### BEST MODE FOR CARRYING OUT THE INVENTION

Hereinafter, preferred embodiments of the present invention will be described with reference to the accompanying drawings.

When assigning reference numerals to components in respective figures, it should be understood that like reference numerals denote like elements although the same elements are shown in the different figures.

Further, when it is determined that a specific description on the related art configuration or function associated with the present invention can make the spirit or scope of the present invention unclear, the detailed description thereof will be omitted herein.

In the present invention, an in-water discharging apparatus for making water into a plasma-ionized state is used to conduct in-water discharging and to allow the generated anions (O⁻, O₃⁻, OH⁻, HOCl, H₂O₂) to sterilize germs, virus, bacteria and the like in water.

The in-water plasma discharging apparatus of the present invention can induce in-water discharging and thus generate a large quantity of anions (O⁻, O₃⁻, OH⁻, HOCl, H₂O₂) even when extremely low voltages are applied thereto. To generate anions even at a low voltage, a water breakdown mechanism (referred also to as an in-water discharging) should be used. The in-water discharging, i.e. in-water plasma discharging, is expressed as a bubble mechanism. The principle of the bubble mechanism is as follows. Ionized impurities and electrolytically ionized OH⁻ in water create a nucleation site in a cellular region (i.e., asperities) on a cathode to which a voltage is applied, so that an extremely high localized electric field region is created to induce local heating so that bubbles can be created through the vaporization of water molecules (H₂O). If bubbles are created, they create an electrical conduction channel between two electrodes while propagating at a high speed in a direction from cathode and anode. This corresponds to in-water discharging by the bubble mechanism. As the surface area of the cathode and anode becomes smaller, the discharging can occur even at lower voltages.

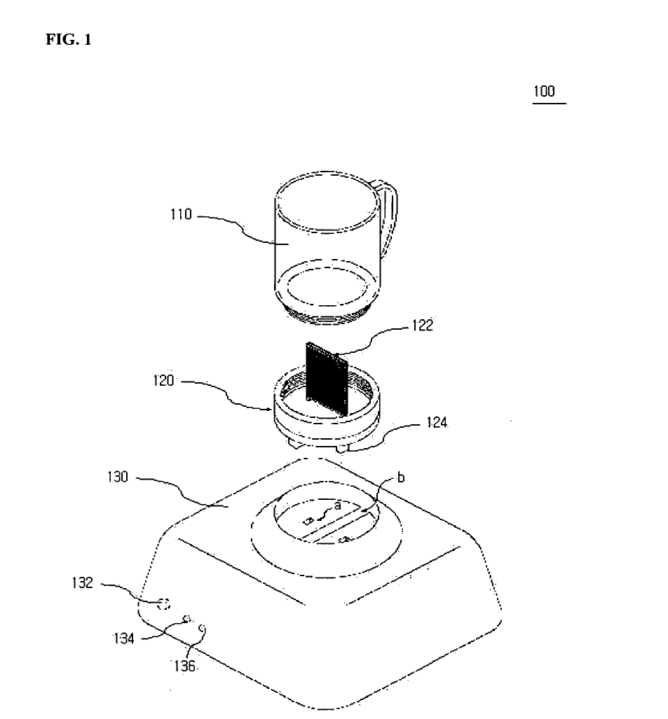

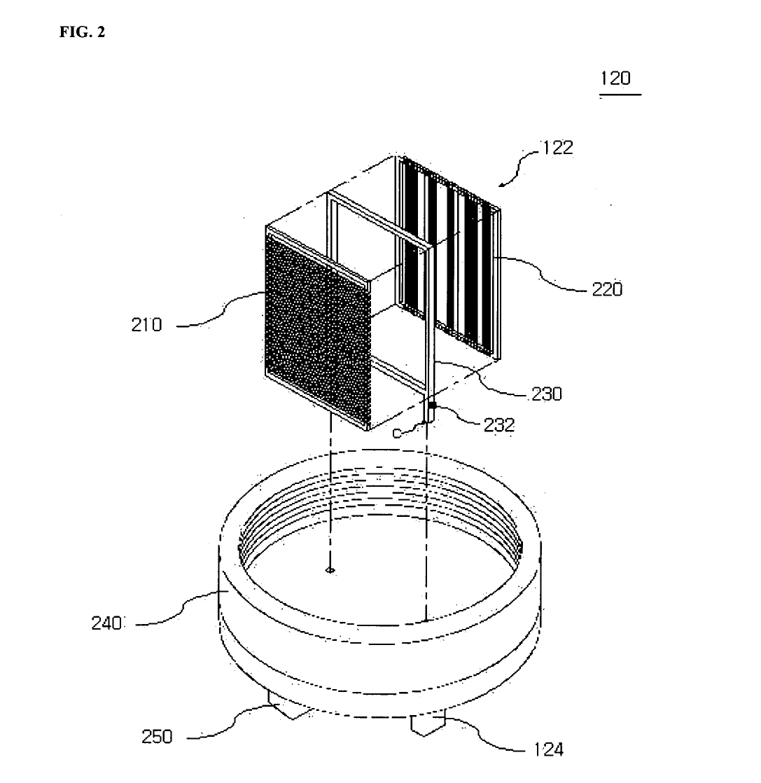

FIG. 1 is a perspective view showing the external configuration of an ionized-water supplying apparatus 100 using the in-water plasma discharging according to a first embodiment of the present invention.

As shown in FIG. 1, the ionized-water supplying apparatus 100 of the present invention comprises a vessel 110 for containing water therein, an in-water plasma ionizing unit 120 for making the water in the vessel 110 into an in-water plasma-ionized state through in-water plasma discharging, and an electric power control unit 130 for controlling the supply of electric power needed to operate the in-water plasma-ionizing unit 120.

The vessel 110 takes the shape of a hollow cylindrical cup with no bottom. A cup handle 112 is formed on the outer periphery of the vessel 110 to allow the vessel 110 to be easily lifted or moved. Threads, e.g. male threads, are formed along the lower circumferential end of the vessel 110 at a predetermined length such that the vessel is engaged with the in-water plasma-ionizing unit 120.

The in-water plasma-ionizing unit 120 includes an in-water discharging unit 122 for inducing in-water discharging according to the supply of electric power. Further, connection terminals 124 protrude from the bottom of the in-water plasma-ionizing unit to provide an electric power supplying path from the electric power control unit 130. The in-water discharging unit 120 takes the shape of a rectangle and is fixed to the floor of the in-water plasma-ionizing unit 120. Further, the in-water discharging unit 122 is manufactured by winding one of two conductive wires in a transverse direction and winding the other wire in a longitudinal direction. The interval between the transversely and longitudinally wound wires is within a range of 0.1 mm˜30 mm, and the two wound wires have opposite polarities to each other.

Although it has been described that the vessel 110 and the in-water plasma-ionizing unit 120 are threadedly engaged with each other, they may be coupled with each other in other coupling manners, e.g. using a buckle. Accordingly, the configuration of the in-water plasma-ionizing unit 120 may vary according to the coupling manner used.

The electric power control unit 130 is configured to support the in-water plasma-ionizing unit 120 with the vessel 110 fasted thereto and to supply the in-water plasma-ionizing unit 120 with electric power. A structure for accommodating the in-water plasma-ionizing unit 120 is formed at the upper portion of the electric power control unit 130. That is, connection grooves a, into which the connection terminals are inserted, and a support groove b, by which the in-water plasma ionizing unit 120 is firmly supported, are formed. Further, the electric power control unit 130 includes a power switch 132 for switching the supply of electric power on or off, a power LED 134 for indicating a power standby state, an operating LED for indicating a state where the operation of the in-water plasma-ionizing unit 120 has been completed after the power switch 132 was switched on, and the like.

FIG. 2 is an exploded perspective view of the in-water plasma-ionizing unit 120.

As shown in FIG. 2, the in-water plasma-ionizing unit 120 is generally divided into an in-water discharging unit 122 and a connector 240. The in-water discharging unit 122 is again divided into an electrode cell 210, an opposed electrode cell 220 and a frame 230.

The electrode cell 210 and the opposed electrode cell 220 have opposite polarities to each other. Although a good conductive material such as platinum wire is employed in the present invention, other conductive materials may be used. The electrode cell 210 is configured in a rectangular form by sequentially arranging a plurality of platinum wires in a transverse direction, while the opposed electrode cell 220 is configured in a rectangular form by sequentially arranging a plurality of platinum wires in a longitudinal direction. The in-water discharging unit 122 is manufactured by fixing the rectangular electrode and opposed electrode cells 210 and 220 to the frame 230. Connection pins c and d protrude from the lower end of the frame 230 at opposite lateral sides thereof. When the in-water discharging unit 122 is coupled with the connector 240, the connection pins c and d of the in-water discharging unit 122 are inserted into the connection grooves formed on the floor of the connector 240. When electric power is supplied from the electric power control unit 130 to the in-water discharging unit 122, positive (+) electric power is applied to one connection pin c while negative (−) electric power is applied to the other connection pin d. Furthermore, a sensor 232 for sensing the presence of water in the vessel 110 is provided at a lower end of the frame 230.

The connector 240 takes the shape of a hollow cylinder of which the inner diameter is equal to the outer diameter of the lower end of the vessel 110. The connector 240 has a bottom surface, and the grooves into which the connection pins c and d of the in-water discharging unit 122 are inserted are formed on the bottom surface. Further, threads, e.g. female threads, are formed along the cylindrical inner periphery of the vessel 110 at a length corresponding to the length of the threads of the vessel 100. The connection terminals 124 protrude from the bottom of the connector 240 along extension lines of the grooves, respectively, in which the connection pins c and d are inserted. Further, a support protrusion 250 in the form of a rectangular rod, which allows the in-water discharging unit 122 of the in-water plasma-ionizing unit 120 not to rock when the in-water plasma-ionizing unit 120 is seated on the electric power control unit 130, is formed on the bottom of the connector 240.

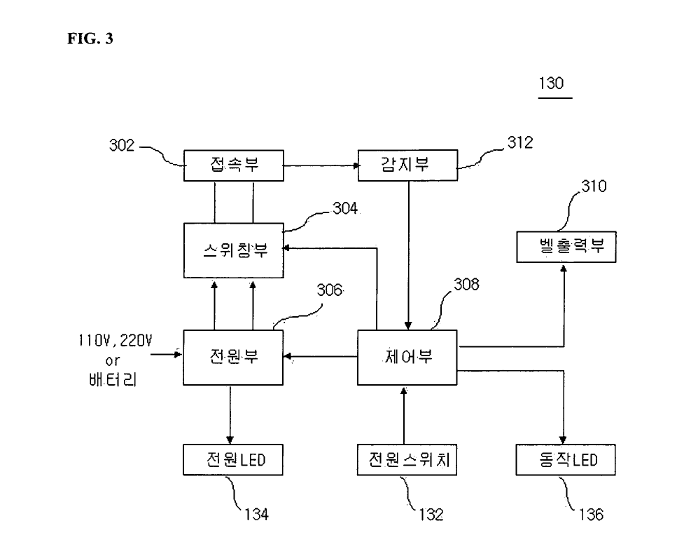

FIG. 3 is a block diagram schematically illustrating the internal configuration of the electric power control unit 130.

As shown in FIG. 3, the electric power control unit 130 comprises a connection section 302, a switching section 304, a power section 306, a control section 308, a bell output section 310, the power LED 134, the power switch 132, the operating LED 136 and the like.

The connection section 302 is a part to which the connection terminals 124 of the in-water plasma-ionizing unit 120 are connected, and includes the connection grooves a into which the connection terminals 124 of the in-water plasma-ionizing unit 120 are received.

The switching section 304 serves to switch the supply of electric power from the power section 306 on or off in response to the control section 308. For example, a variety of switching elements such as a PNP transistor, an NPN or PNP transistor, a relay and a field effect transistor (FET) can be used as the switching section 304.

The power section 306 converts AC electric power applied from the outside (a receptacle) into DC electric power and then outputs the converted DC power. In the present invention, AC power of 110V or 220V is preferably converted into DC power of 1.5V to 100V which in turn is output.

When the power switch 132 is switched on, the control section 308 applies an ON control signal to the switching section 304 and causes the DC power to be supplied from the power section 306 to the in-water plasma-ionizing unit 120 via the connection section 302. Further, after the set operating time has elapsed, the control section 308 applies an OFF control signal to the switching section 304 and causes the supply of electric power to be terminated. Furthermore, the control section 308 outputs bell sound or music to the bell output section 310 and also turns on the operating LED 136 to indicate that a user can use water in the vessel 110.

The bell output section 310 outputs the bell sound, music or the like under the control of the control section 308.

When the sensor 232 senses the water, a sensing section 312 transmits the sensed signal to the control section 308.

Next, the preferred operation of the ionized-water supplying apparatus 100 using in-water plasma discharging configured as above will be described.

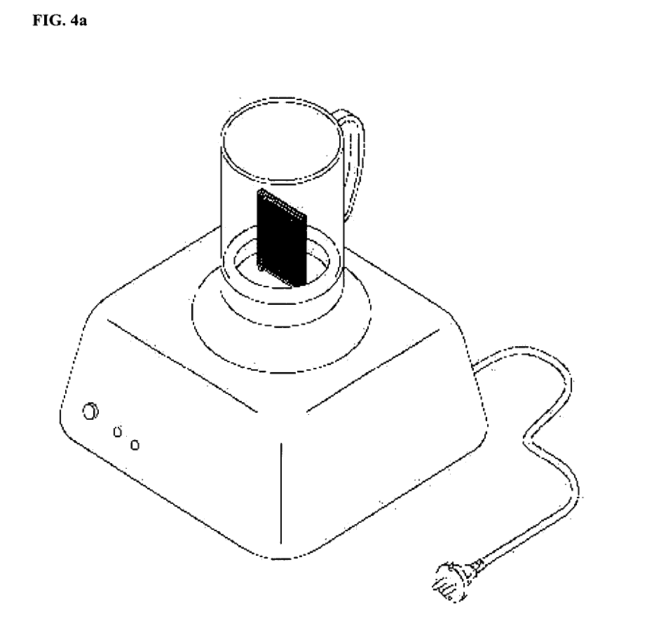

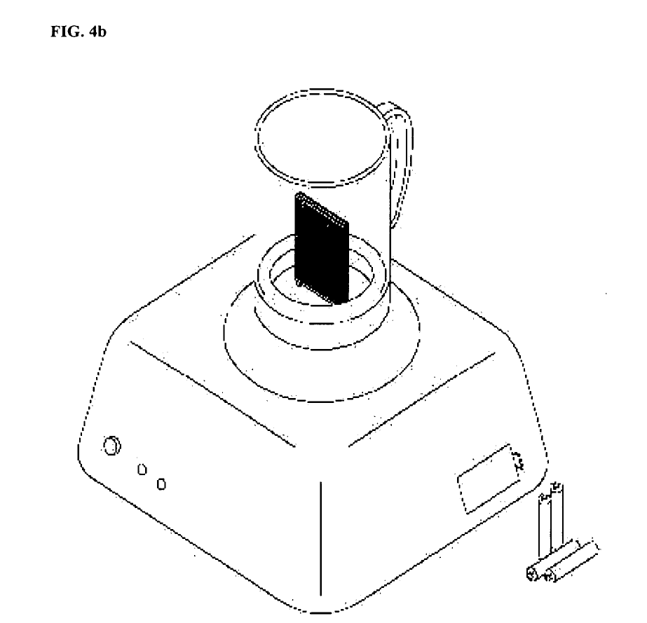

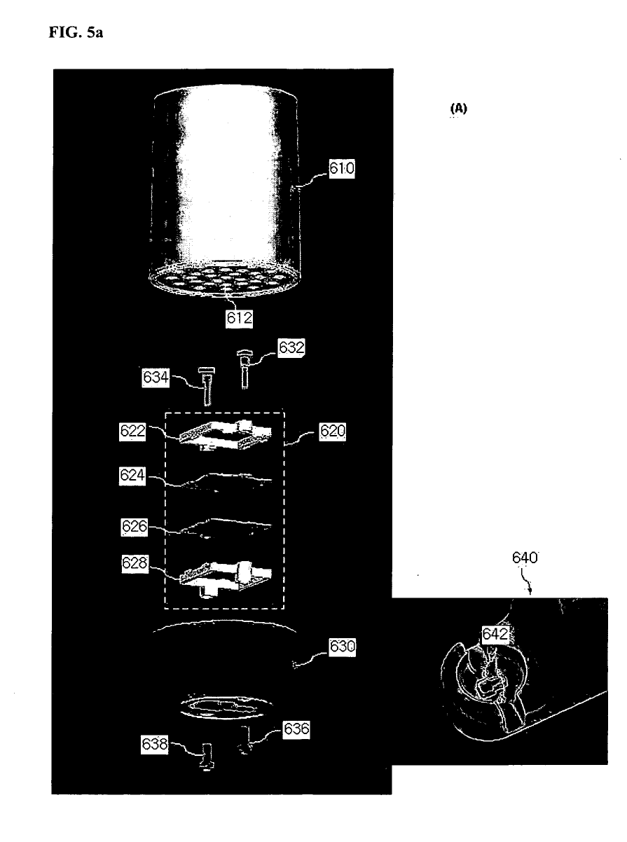

FIGS. 4a and 4b show a state where the in-water plasma-ionizing unit 120 with the vessel 110 fastened thereto is seated on the electric power control unit 130.

Referring to FIG. 4a, a power plug 510 with an electrical cord connected thereto is provided to supply the ionized-water supplying apparatus 100 with electric power. When intending to supply the electric power control unit 130 with electric power, the user merely inserts the power plug 510 of the ionized-water supplying apparatus 100 into a 110V or 220V receptacle (not shown) such that electric power can be applied to the ionized-water supplying apparatus 100. Of course, as shown in FIG. 4b, electric power may be supplied by using a secondary battery such as a dry cell or battery. At this time, the secondary battery is stepped up to DC 1.5V to DC 100V and then used.

The AC electric power is applied from the receptacle to the power section 306 of the electric power control unit 130 via the power plug 510 and the electric cord 520. If the power is applied to the electric power control unit 130, the power LED 134 is turned on to indicate that the power has been applied. At this time, the power applied to the power section 306 is transmitted to the switching section 304 and is in a standby state at the switching section 304 because the switching section 304 is usually in an OFF state.

When the power LED 134 of the ionized-water supplying apparatus 100 is indicated, the user fills the vessel 110 with water in full or part.

After the vessel 110 is filled up with water, the user turns on the power switch 132 to purify the water in the vessel. When the power switch 132 is switched on, the control section 308 of the electric power control unit 130 applies the ON signal to the switching section 304 and causes the switching section 304 to be switched on. Therefore, the standby power in the switching section 304 is applied to the in-water discharging unit 122 via the connector 302 and the connection terminals 124 of the in-water plasma-ionizing unit 120. At this time, if a sensed signal is not consequently applied from the sensing section 312 to the control section 308 because water is not sensed by the sensor 232, the control section 308 does not switch on the switching section 304.

Positive and negative power can be applied from the power section 306 to the switching section 304. In the present invention, the control section 308 controls the switching section 304 such that positive and negative voltages can be alternately supplied every one to five minutes. Thus, the polarity of the connection terminal 124 is changed each time the power is alternately supplied.

The power is applied to the in-water discharging unit 122 through the connection pins c and d connected to the connection terminals 124. In the in-water discharging unit 122, cathode power and anode power are applied to the electrode cell 210 and the opposed electrode cell 220, respectively. Therefore, in the in-water discharging unit 122, in-water discharging occurs in a direction from cathode to anode.

The ionized impurities and electrolytically separated anions adhere to the electrode cell 210 and opposed electrode cell 220 of the in-water discharging unit 122 such that a nucleation site is formed. This nucleation site becomes a localized field enhancement region in which high current density is locally created, water is locally heated, and bubbles are then created while the water molecules evaporate. Once bubbles are created, they are expanded such that a conduction channel is created from the cathode (+) electrode to the anode (−) electrode. This is in-water discharging by the bubble mechanism. When in-water discharging occurs, oxidizing and sterilizing materials such as O⁻, O₃⁻, OH⁻, HOCl, H₂O₂ are created from the water.

The anions (O⁻, O₃⁻, OH⁻, HOCl, H₂O₂) so created allow heavy metals and ionized impurities dissolved in the water to be converted into harmless materials through the oxidization process and then a variety of germs, virus and bacteria in the water to be sterilized.

Due to the anions created and dissolved in the water by the in-water discharging unit 122, the water in the vessel 110 is converted into sterilized water with disinfecting action. Therefore, the water in the vessel 110 is effective in eliminating bad smells in the mouth. Further, the water in the vessel 110 is effective in curing gingival disease because the water can sterilize germs or bacteria in the mouth. In addition, since the sterilizing or disinfecting water contains anions (O₃⁻, HOCl, H₂O₂), the water can not only sterilize viruses, bacteria and the like adhering to vegetables, fruits, dishes and the like, but also cause heavy metals and harmful compounds adhering to the vegetables, fruits, dishes and the like to be converted into harmless materials through oxidization thereof.

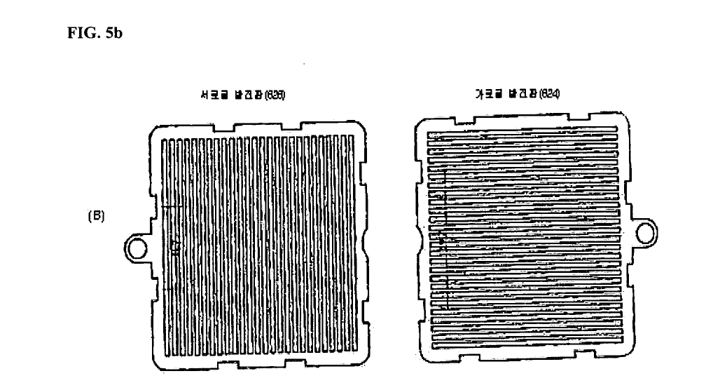

FIG. 5 is a perspective view showing the external configuration of an ionized-water supplying apparatus 600 using plasma discharging according to a second embodiment of the present invention.

As shown in FIG. 5a, the ionized-water supplying apparatus 600 according to the second embodiment of the present invention comprises a water tank 610 for containing water, an in-water discharging unit 620 for making the water in the water tank 610 into a plasma-ionized state through in-water discharging, a coupling/supporting unit 630 for coupling the water tank 610 and the in-water discharging unit 620 with each other and supporting them, and an electric power supply unit 640 for supplying and controlling electric power necessary to the in-water discharging of the in-water discharging unit 620.

The water tank 610 takes the shape of a hollow cylindrical cup and includes an open top end and a bottom end with a plurality of holes formed therein. A tank handle may be formed on the outer periphery of the water tank 610 to allow the water tank 610 to be easily lifted and moved. The water tank 610 is fastened to the coupling/supporting unit 630 via the in-water discharging unit 620 by using fastening screws 632 and 634 which are insert injection molded in the holes in the bottom of the water tank 610. Further, the in-water discharging unit 620 and the coupling/supporting unit 630 may be fastened to each other by means of vacuum welding.

The in-water discharging unit 620 reacts with water and induces the in-water discharging when electric power is supplied thereto, and includes a transverse discharging frame 622, a transverse discharging plate 624, a longitudinal discharging plate 626 and a longitudinal discharging frame 628. Electric power is supplied from the electric power supply unit 640 to the transverse and longitudinal discharging plates 624 and 626 via the fastening screws 632 and 634 and fastening nuts 636 and 638 which are fastened to each other. The transverse and longitudinal discharging plates 624 and 626 of the in-water discharging unit 620 have opposite polarities to each other and are made in the form of a titanium electrode plate which is plated with a good conductive material such as platinum.

As shown in FIG. 5b, the transverse discharging plate 624 is configured in such a manner that platinum is plated on the titanium plate with a plurality of stripped lines formed thereon in a transverse direction, and the longitudinal discharging plate 626 is configured in such a manner that platinum is plated on the titanium plate with a plurality of stripped lines formed thereon in a longitudinal direction. The in-water discharging unit 620 is configured by fastening the rectangular transverse and longitudinal discharging plates 624 and 626 to the transverse and longitudinal discharging frames 622 and 628 with the fastening screws 632 and 634 and the fastening nuts 636 and 638. Furthermore, the transverse and longitudinal discharging frames 622 and 628 are made of a non-conducting material to cause the transverse and longitudinal discharging plates 624 and 626 to be spaced apart from each other.

When fastening the transverse and longitudinal discharging plates 624 and 626, respectively, to the transverse and longitudinal discharging frames 622 and 628, numerous virtual cross points are created in the water by means of the stripped lines of the transverse and longitudinal discharging plates 624 and 626.

The electric power supply unit 640 includes a recess for accommodating the coupling/supporting unit 630 with the in-water discharging unit 620 fastened thereto, and a conductive contact terminal 642 which protrudes from the floor of the power supply unit 640 and is then brought into contact with the fastening nuts 636 and 638. Although it is not shown in FIG. 5a, the electric power supply unit 640 further includes a power switch for switching the supply of electric power on or off, a power LED for indicating a power standby state, an operating LED for indicating a state where the operation of the in-water discharging unit 620 has been completed after the power switch was switched on, and the like.

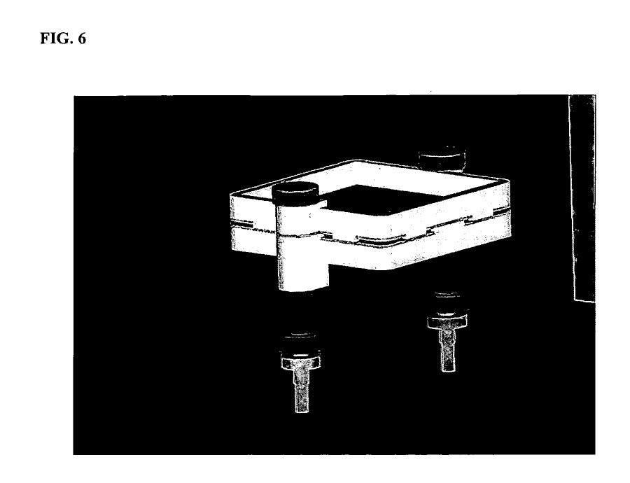

FIG. 6 is a perspective view of the in-water discharging unit 620 mounted with a single set of in-water discharging plates.

As shown in FIG. 6, the in-water discharging unit 620 mounted with the single set of discharging plates is configured in such a manner that the transverse and longitudinal discharging plates 624 and 626 are fastened to the transverse and longitudinal discharging frames 622 and 628, respectively, in a single layer form. Further, the fastening screws 632 and 634 are inserted through the transverse discharging plate 624 and the fastening nuts 636 and 638 are inserted through the longitudinal discharging plate 626. Then, the fastening screws 632 and 634 and the fastening nuts 636 and 638 are fastened together.

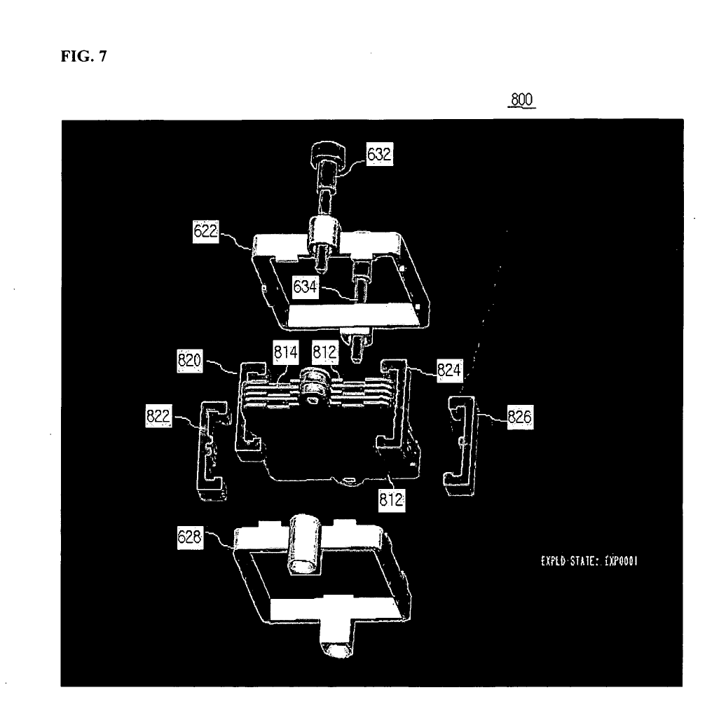

FIG. 7 is an exploded perspective view of an in-water discharging unit mounted with the multiple sets of the in-water discharging plates.

As shown in FIG. 7, the in-water discharging unit 800 mounted with multiple sets of in-water discharging plates includes a plurality of (i.e., N) transverse discharging plates 812 and a plurality of (i.e., N) longitudinal discharging plates 814 which are spaced apart from and coupled with each other by means of a plurality of multi-layer separating bars 820, 822, 824 and 826. Since the N transverse and longitudinal discharging plates 812 and 814 are assembled into the in-water discharging unit 800 in this embodiment, the total in-water discharging amount is increased (N−1) times as much as that of the first embodiment. Accordingly, a time taken to create the sterilizing water will be reduced in the ratio of 1/(N−1) as compared with in the first embodiment, or the sterilizing water will be created (N−1) times as much sterilizing water will be created as in the first embodiment if the time taken to create the sterilizing water is the same as in the first embodiment.

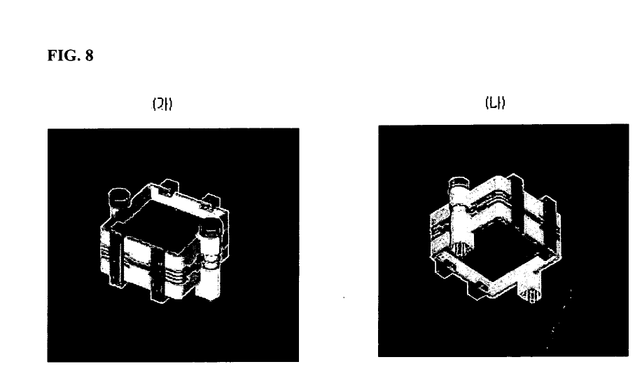

FIG. 8 is an assembled perspective view of the in-water discharging unit mounted with the multiple sets of in-water discharging plates.

FIG. 8 (a) is a perspective view of the assembled in-water discharging unit 800 as viewed obliquely from above, and FIG. 8 (b) is a perspective view of the in-water discharging unit 800 as viewed obliquely from below.

As shown in FIG. 8, the in-water discharging unit 800 is configured in such a manner that the plurality of transverse and longitudinal discharging plates 812 and 814 are stacked one above another, the transverse and longitudinal discharging frames 622 and 628 are respectively placed on the top and bottom of the stacked discharging plates, and the transverse and longitudinal discharging plates 812 and 814 and the transverse and longitudinal discharging frames 622 and 628 are altogether firmly supported and coupled by the multi-layer separating bars 820, 822, 824 and 826.

In addition, two fastening holes through which the fastening screws 632 and 634 are inserted are formed at opposite lateral sides of each of the transverse and longitudinal discharging plates 812 and 814 and the transverse and longitudinal discharging frames 622 and 628. The fastening holes are aligned when the discharging plates and frames are stacked one above another, and the fastening screws 632 and 634 are then inserted through the fastening holes to finish assembling the in-water discharging unit.

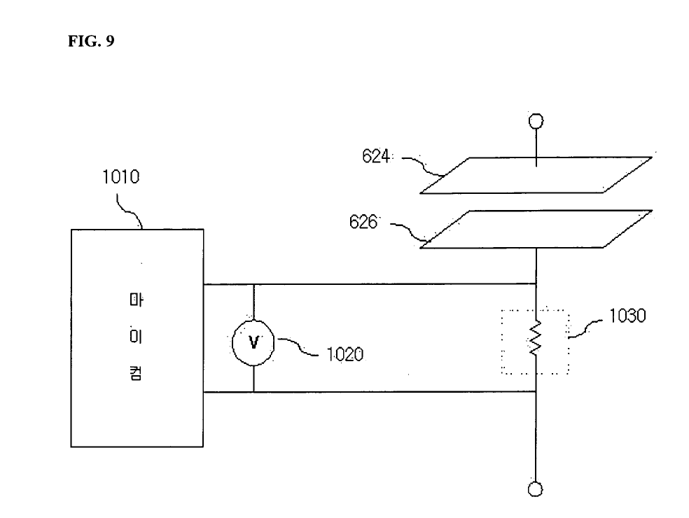

FIG. 9 is a view illustrating the partial configuration of the electric power supply unit for supplying the ionized-water supplying apparatus 600 with electric power.

As shown in FIG. 9, the power supply unit 640 comprises a microcontroller 1010, a voltage generating section 1020 for generating voltage under the control of the microcontroller 1010, and a resistor section 1030 for generating current according to the voltage.

The microcontroller 1010 measures the value of the current with respect to the voltage and converts the measured current value into digital data because it includes an A/D converter.

The ionized-water supplying apparatus 600 of the present invention is operated in such a manner that DC electric power is applied from the electric power supply unit 640 to the in-water discharging unit 620, and water (H₂O) in the water tank is decomposed into the anions such as O⁻, O₃⁻, OH⁻, HOCl, and H₂O₂ by the in-water discharging unit 620. At this time, since the ionized-water supplying apparatus 600 is operated in avalanche mode, the conductive materials plated onto the discharging plates are worn out if the ionized-water supplying apparatus is used for a long time. Accordingly, the operating performance of the in-water discharging plates 624 and 626 are greatly reduced and thus should be inevitably exchanged. Therefore, as shown in FIG. 9, an automatic diagnostic circuit for automatically diagnosing a worn state of the in-water discharging plates 624 and 626 is further provided in the ionized-water supplying apparatus 600.

Referring to FIG. 9, the microcontroller 1010 measures the voltage applied to the shunt resistance of the resistor section 1030 and also measures the current value using the A/D converter housed within the microcontroller 1010. If the measured current value is equal to or greater than a predetermined value defined in the software program of the microcontroller 1010, it is recognized that the water tank 610 with the in-water discharging unit 620 fastened thereto is seated on the electric power supply unit 640. If the measured current value is a numerical value (an already set value) almost close to 0 (zero), a message “No Cup” indicating that the water tank 610 is not seated on the electric power supply unit 640 is displayed. If the measured current value is equal to or lower than about 80% of a normal value (an already set value), a message “Change Cup” is displayed. That is, if the message “No Cup” or “Change Cup” is displayed on a display unit, even though the water tank 610 is seated on the electric power supply unit 640, the user can recognize that in case of “No Cup”, the cup (water tank) is erroneously positioned or the ionized-water supplying apparatus was operated in a state where there is no water in the cup, and that in case of “Change Cup”, the cup should be exchanged with a new cup because it means a state where the discharging plates of the in-water discharging unit 620 are worn out and thus replaced.

Next, the operation of the ionized-water supplying apparatus 600 using in-water plasma discharging according to the second embodiment of the present invention will be described.

If the user places the water tank 610 with the in-water discharging unit 620 fastened thereto onto the electric power supply unit 640 and then turns the switch on, positive and negative electric power is applied from the power supply unit 640 to the in-water discharging unit 620. If necessary, the microcontroller 1010 can control the power supply unit 640 such that the positive (+) and negative (−) voltages are alternately supplied every one to five minutes. Thus, the polarities of the transverse and longitudinal discharging plates 624 and 626 are changed every time whenever electric power is alternately supplied.

In the electric power supply unit 640, the electric power is applied to the in-water discharging unit 620 through the contact terminal 642 via the fastening screws 636 and 638 and the fastening nuts 632 and 638. Further, in the in-water discharging unit 620, the cathode and anode power is applied to the transverse and longitudinal discharging plates 624 and 626, respectively. In the in-water discharging unit 620, therefore, the in-water discharging occurs in the cathode to anode direction.

The ionized impurities and electrolytically separated anions adhere to the transverse and longitudinal discharging plates 624 and 626 of the in-water discharging unit 620 such that a nucleation site is formed. This nucleation site becomes a localized field enhancement region in which the high current density is locally created, water is locally heated, and bubbles are then created while the water molecules evaporate. Once bubbles are created, they are expanded such that a conduction channel is created from the cathode (+) electrode to the anode (−) electrode. The in-water discharging due to the bubble mechanism occurs through the above process.

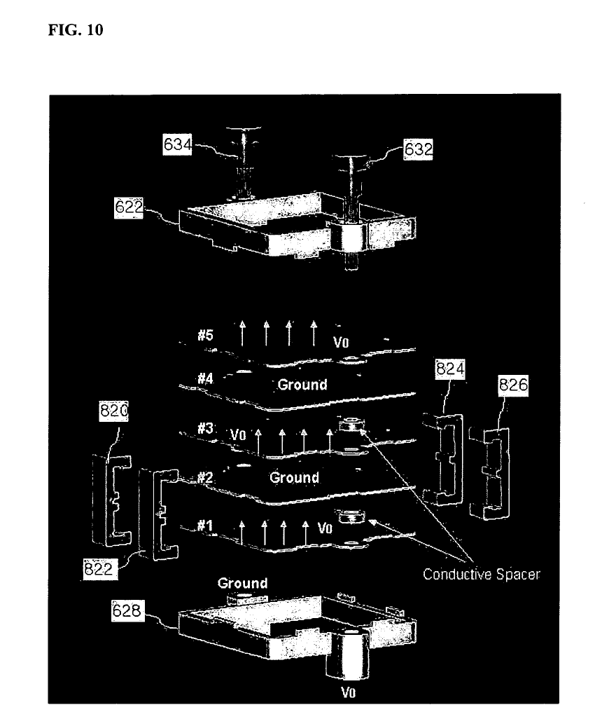

FIG. 10 is an exploded perspective view illustrating the operating principle of the in-water discharging unit 620.

Referring to FIG. 10, if a voltage V₀ is applied to the in-water discharging unit 620, an avalanche breakdown mechanism occurs, due to the distribution of the voltage V₀ and the ground applied to the respective discharging plates, at the numerous virtual cross points in a space defined between the #1 and #2 discharging plates in a state where the top surface of the #1 discharging plate and the bottom surface of the #2 discharging surface are spaced apart by a distance du. Such an operation occurs between the top surface of the #2 discharging plate and the bottom surface of the #3 discharging plate, between the top surface of the #3 discharging plate and the bottom surface of the #4 discharging plate, and between the top surface of the #4 discharging plate and the bottom surface of the #5 discharging plate. That is, in a case where there are N discharging plates, a switch comprising numerous virtual cross points where the (N−1) avalanche breakdown mechanisms occur is formed.

According to the avalanche breakdown mechanism, when voltage V0 is applied to the two electrode points P1 and P1′ which are spaced apart from each other by a distance d (mm) in water, an electric field is created as expressed in the following equation (1).

$$E = \frac{{V}_{0} ( Voltage )}{d ( mm )}$$

At this time, if the electric field exceeds a critical value of the avalanche breakdown mechanism, exemplary processes of the avalanche breakdown mechanism in water such as Nucleation Site Formation, Localized High Electric Field Domain, Localized High Current Density Domain, Localized High Temperature Domain, Evaporation, Bubble Formation, Bubble Expansion, Conduct Channeling and Restart are repeated.

Since the in-water discharging unit 620 causes the water in the water tank 610 to contain the anions (O⁻, O₃⁻, OH⁻, HOCl, H₂O₂) during the above processes, the water can have oxidization and sterilization qualities. Therefore, when the water in the water tank 610 is introduced into the mouth of the user, it can be effectively used to eliminate bad smells in the mouth. Further, since the water in the water tank 610 can sterilize germs or bacteria in the mouth, it can be effectively used to prevent and cure a variety of gingival diseases.

According to the preferred embodiments of the present invention as described above, since the in-water discharging unit for causing the water in the water tank 610 to be subjected to in-water discharging is configured to have a plurality of layers (i.e., N layers), the discharging unit can create in-water discharging operation (N−1) times as strong as the in-water discharging unit with only two discharging plates, thereby maximizing the efficiency of the in-water discharging. Moreover, since the anionic water in which O⁻, O₃⁻, OH⁻, HOCl and H₂O₂ are dissolved is created due to the in-water discharging operation in the water tank 610, an ionized-water supplying apparatus for sterilizing a variety of germs, viruses, bacteria and the like in water can be realized.

According to the present invention as described above, water containing anions (O⁻, O₃⁻, OH⁻, HOCl, H₂O₂) can be used to eliminate foul breath and also to maintain a feeling of freshness for a long time.

Further, since germs or bacteria, which generally cause gingival diseases, are sterilized while the mouth is cleansed with anionized water, a variety of gingival diseases can be prevented and cured.

Furthermore, the anion-containing water can be used to sterilize viruses or bacteria adhering to vegetables, fruits, dishes and the like, and also to cause the heavy metals and harmful compounds adhering to the vegetables, fruits, dishes and the like to become harmless.

Moreover, since the in-water plasma-ionizing unit 120 and the electric power control unit 130 can be detached from each other, the vessel can be easily exchanged when something is wrong with the in-water plasma-ionizing unit 120.

In addition, in-water discharging performance in the water tank 610 can be enhanced by using the multi-layered discharging plates, and sterilizing water with superior sterilizing action and a large quantity of the sterilizing water, if necessary, can be obtained.

Also, since the user can recognize a state where the discharging plates are worn out due to the in-water discharging operation and timely exchange the worn discharging plates, sterilizing water can be created while being always kept in an excellent state of in-water discharging performance.

The foregoing descriptions are merely illustrate the technical spirit of the present invention by way of example, and

Although the present invention has been described in connection with the preferred embodiments, it will be apparent to those skilled in the art that various changes and modifications can be made thereto without departing from the scope and spirit of the present invention.

Therefore, the embodiments of the present invention are not to limit but to illustrate the technical spirit of the present invention, and thus, the scope of the present invention should not be restricted by the embodiments.

Accordingly, the true scope of the present invention should be defined by the appended claims, and all the changes, modifications and equivalents within the technical spirit of the present invention should be constructed as falling within the scope of the present invention.

1. An ionized-water supplying apparatus for producing sterilizing water using anions created by making water into an in-water plasma-ionized state through an in-water discharging operation, comprising:
a vessel (110) for containing water;
an in-water plasma-ionizing unit (120) for making the water in the vessel (110) into an in-water plasma-ionized state through the in-water discharging operation; and
an electric power control unit (130) for controlling supply of electric power needed to operate the in-water plasma-ionizing unit (120).

2. The apparatus as claimed in claim 1, wherein the vessel (110) takes the shape of a hollow cylindrical cup with no bottom and are formed with threads along a lower circumferential end of the vessel (110) at a predetermined length such that the vessel is engaged with the in-water plasma-ionizing unit (120).

3. The apparatus as claimed in claim 1, wherein the in-water plasma-ionizing unit (120) includes an in-water discharging unit (122) for causing the in-water discharging according to the supply of electric power and a connector (240) for fixing the in-water discharging unit (122) thereto;
a connection terminal (124) for providing an electric power supplying path from the electric power control unit (130) protrudes from the bottom of the in-water plasma-ionizing unit (120); and
the in-water discharging unit (122) is fixed onto the floor of the in-water plasma-ionizing unit (120) and includes a sensor (232) for sensing the presence of water.

4. The apparatus as claimed in claim 3, wherein the in-water discharging unit (122) includes an electrode cell (210), an opposed electrode cell (220) and a frame (230);
the electrode cell (210) and the opposed electrode cell (220) have opposite polarities to each other; and
the electrode cell (210) is configured by sequentially arranging a plurality of conductive wires in a transverse direction, the opposed electrode cell (220) is configured by sequentially arranging a plurality of conductive wires in a longitudinal direction, the in-water discharging unit (122) is configured by fixing the electrode cell (210) and the opposed electrode cell (220) to the frame (230), and connection pins (c, d) protrude from a lower end of the frame (230) at opposite lateral sides thereof.

5. The apparatus as claimed in claim 3, wherein the in-water discharging unit (120) is configured by winding one of two conductive wires in a transverse direction and winding the other wire in a longitudinal direction such that an interval between the transversely and longitudinally wound wires is within a range of 0.1 mm˜30 mm, and the two wound wires have opposite polarities to each other.

6. The apparatus as claimed in claim 1, wherein the electric power control unit (130) includes a connection section (302) with the connection terminal (124) of the in-water plasma-ionizing unit (120) connected thereto and including a connection grooves (a) for accommodating the connection terminal (124) therein; a power section (306) for converting AC electric power into DC electric power and outputting the converted DC power; a switching section (304) for switching on or off the supply of electric power from the power section (306) to the connection section (302); a control section 308 for causing an ON control signal to be applied to the switching section (304) and the DC power to be supplied from the power section (306) to the in-water plasma-ionizing unit (120) via the connection section (302) when the power switch (132) is switched on, and causing an OFF control signal to be applied to the switching section (304) and the electric power to be cut off after a predetermined time has elapsed; a bell output section (310) for outputting a bell sound or music under the control of the control section (308), and a sensing section (312) for transmitting a sensed signal to the control section (308) when a sensor (232) senses the presence of water.

7. The apparatus as claimed in claim 4, wherein the in-water discharging occurs in such a manner that:
ionized impurities and electrolytically ionized anions adhere to the electrode cell (210) and the opposed electrode cell (220) to create a nucleation site thereon;
the nucleation site becomes a localized field enhancement region in which high current density is locally created, water is locally heated, and bubbles are then created while water molecules evaporate; and
the bubbles are then expanded such that a conduction channel is created from the cathode (+) electrode to the anode (−) electrode.

8. The apparatus as claimed in claim 1, wherein the electric power control unit (130) includes a dry cell and a secondary battery.

9. (canceled)

10. An ionized-water supplying apparatus for producing purified water with disinfecting action using anions created by making water into an in-water plasma-ionized state through an in-water discharging operation, comprising:
a water tank (610) for containing water;
an in-water discharging unit (620) for making the water in the water tank (610) into an in-water plasma-ionized state through the in-water discharging operation;
a coupling/supporting unit (630) for coupling and supporting the water tank (610) and the in-water discharging unit (620); and
an electric power supply unit (640) for supplying and controlling electric power needed for the in-water discharging operation of the in-water discharging unit (620).

11. The apparatus as claimed in claim 10, wherein the water tank (610) takes the shape of a hollow cylindrical cup and includes an open top end and a bottom end with a plurality of holes formed therein, and is fastened to the coupling/supporting unit (630) via the in-water discharging unit (620) by inserting fastening screws (632, 634) into the holes formed in the bottom of the water tank (610).

12. The apparatus as claimed in claim 10, wherein the in-water discharging unit (620) reacts with the water and induces the in-water discharging when the electric power is supplied thereto, and includes a transverse discharging frame (622), a transverse discharging plate (624), a longitudinal discharging plate (626) and a longitudinal discharging frame (628); and the electric power is supplied from the electric power supply unit (640) to the transverse and longitudinal discharging plates (624, 626) of the in-water discharging unit (620) via the fastening screws (632, 634) and fastening nuts (636, 638) which are fastened to each other.

13. The apparatus as claimed in claim 10, wherein the in-water discharging unit (620) and the coupling/supporting unit (630) are fastened to each other through vacuum welding.

14. The apparatus as claimed in claim 10, wherein the electric power supply unit (640) includes a recess for accommodating the coupling/supporting unit (630) with the in-water discharging unit (620) fastened thereto, and a conductive contact terminal (642) which protrudes from the floor thereof and is then brought into contact with the fastening nuts (636, 638); and
the electric power supply unit (640) further includes a power switch for switching the supply of electric power on or off, a power LED for indicating a power standby state, and an operating LED for indicating a state where the operation of the in-water discharging unit (620) has been completed after the power switch was switched on.

15. The apparatus as claimed in claim 10, wherein the DC electric power supplied from the electric power supply unit (640) to the in-water discharging unit (620) is such that positive (+) and negative (−) voltages are alternately supplied every one to five minutes.

16. The apparatus as claimed in claim 12, wherein the fastening screws (632, 634) are insert injection molded into the coupling/supporting unit (630).

17. The apparatus as claimed in claim 12, wherein the in-water discharging unit (620) is configured in such a manner that the transverse and longitudinal discharging plates (624, 626) have opposite polarities to each other, and numerous virtual cross points are created in the water by means of stripped lines of the transverse and longitudinal discharging plates (624, 626) when fastening the transverse and longitudinal discharging plates (624, 626) to the transverse and longitudinal discharging frames (622, 628), respectively; and
the transverse discharging plate (624) is configured by arranging sequentially in a transverse direction a plurality of platinum-plated stripped line electrode plates in the form of a rectangle, and the longitudinal discharging plate (626) is configured by arranging sequentially in a longitudinal direction a plurality of platinum-plated stripped line electrode plates in the form of a rectangle.

18. The apparatus as claimed in claim 14, wherein the electric power supply unit (640) includes a microcontroller (1010) for controlling the supply of electric power, a voltage generating section (1020) for generating voltage under the control of the microcontroller (1010), and a resistor section (1030) for generating current according to the voltage.

19. The apparatus as claimed in claim 17, wherein the in-water discharging unit (620) is configured by fastening the transverse and longitudinal discharging plates (624, 626) to the transverse and longitudinal discharging frames (622, 628) with the fastening screws (632, 634) and the fastening nuts (636, 638) that are insert injection molded in the coupling/supporting unit (630); and the transverse and longitudinal discharging frames (622, 628) are made of a non-conducting material.

20. The apparatus as claimed in claim 10, wherein a plurality of the transverse and longitudinal discharging plates of the in-water discharging unit are coupled with one another in a state where the plates are spaced apart from each other by means of multi-layer separating plates.

21. The apparatus as claimed in claim 18, wherein the microcontroller (1010) measures voltage applied to a shunt resistance of the resistor section 1030 and also measures current value using the A/D converter housed within the microcontroller (1010), and causes a predetermined message “No Cup” to be displayed on a display unit, when the measured current value is equal to or lower than a predetermined value, such that it can be recognized that the water tank (610) is not seated on the electric power supply unit (640) or the apparatus was operated in a state where there is no water in the water tank (610).

22. The apparatus as claimed in claim 14, wherein the DC electric power supplied from the electric power supply unit (640) to the in-water discharging unit (620) is such that positive (+) and negative (−) voltages are alternately supplied every one to five minutes.

23. The apparatus as claimed in claim 12, wherein a plurality of the transverse and longitudinal discharging plates of the in-water discharging unit are coupled with one another in a state where the plates are spaced apart from each other by means of multi-layer separating plates.

24. The apparatus as claimed in claim 17, wherein a plurality of the transverse and longitudinal discharging plates of the in-water discharging unit are coupled with one another in a state where the plates are spaced apart from each other by means of multi-layer separating plates.
